(19) United States
(12) Patent Application Publication
(10) Pub. No.: US 2013/0038667 A1
(43) Pub. Date: Feb. 14, 2013

(54) Ink Container

(71) Applicants: Eyal Bachar, Modi'in (IL); Haim Hochman, Kiriat Onno (IL); Elliad Silcoff, Tel Aviv (IL); Yaron Grinwald, Meitar (IL); Albert Teishev, Rishon le-zion (IL)

(72) Inventors: Eyal Bachar, Modi'in (IL); Haim Hochman, Kiriat Onno (IL); Elliad Silcoff, Tel Aviv (IL); Yaron Grinwald, Meitar (IL); Albert Teishev, Rishon le-zion (IL)

(21) Appl. No.: 13/259,537

(22) PCT Filed: Sep. 25, 2009
(86) PCT No.: PCT/EP2009/062464

§ 371 Date: Dec. 12, 2011

(51) Int. Cl. B41J 2/175

(52) U.S. Cl. 347/85

(57) ABSTRACT

Ink concentrate container, comprising an inner volume, containing ink for liquid electrostatic printing (LEP), the ink comprising a carrier liquid and electrically chargeable toner particles for electrostatic imaging, an outlet, and at least one flexible wall extending along the inner volume, so that ink can be pressed through the outlet out of the inner volume by deforming the flexible wall.

### BACKGROUND OF THE INVENTION

In the art of liquid electrostatic printing (LEP), a latent electrostatic image is produced by first providing a uniform electrostatic charge on a photoconductive imaging surface. A modulated beam of light then selectively discharges the photoconductor in correspondence with an optical image of an original to be copied or a computer generated image, forming an electrostatic charge pattern on the photoconductive imaging surface, i.e. a latent electrostatic image having a background portion at a high potential and a “print” portion at a low potential. The latent electrostatic image can then be developed by applying charged pigmented toner particles, dispersed in a carrier liquid, to the electrostatic image surface, wherein the toner particles adhere to the “print” portions of the photoconductive surface to form a toner image which is subsequently transferred by various techniques to a hard copy (e.g. paper).

A known print system applying LEP is the HP Indigo Digital Press®™. The basic principles of this system, and general LEP techniques, are, amongst others, disclosed in U.S. Pat. Nos. 4,678,317; 4,860,924; 4,980,259; 4,985,732; 5,028,964; 5,034,778; 5,047,808; 5,078,504; 5,117,263; 5,148,222; 5,157,238; 5,166,734; 5,208,130; 5,231,454; 5,255,058; 5,266,435; 5,268,687; 5,270,776; 5,276,492; 5,278,615; 5,280,326; 5,286,948; 5,289,238; 5,315,321; 5,335,054; 5,337,131; 5,376,491; 5,380,611; 5,426,491; 5,436,706; 5,497,222; 5,508,790; 5,527,652; 5,552,875; 5,555,185; 5,557,376; 5,558,970; and 5,570,193. These disclosures are herewith incorporated by reference. Currently, the HP Indigo Digital Press®™ uses ElectroInk®™. The Electrolnk®™ consists of a carrier liquid, containing pigmented polymer toner particles containing charge control agents for electrostatic imaging. Several electrostatic inks are described in U.S. Pat. Nos. 4,794,651; 4,842,974; 5,047,306; 5,407,307; 5,192,638; 5,208,130; 5,225,306; 5,264,312; 5,266,435; 5,286,593; 5,300,390; 5,346,796; 5,407,771; 5,554,476; 5,655,194; 5,792,584; 5,5923,929 and 6,146,803, and PCT Patent publication WO/92/17823. These disclosures are herewith incorporated by reference.

Since the introduction the HP Indigo Digital Press®™ uses cylindrical ink cans containing ink concentrate, named ElectroInk®™. The concentration of the toner particles in the ink concentrate is relatively high. Correspondingly, the ink concentrate has a relatively high viscosity. Originally, the LEP system used high pressures to press the viscous ink out of the can, into the ink tank. The cans are connected to a press and pump arrangement that automatically open the can, and force the ink out of the can using a piston.

Before actual delivery of the toners onto the photoconductive imaging surface, the ink concentrate is diluted in further carrier fluid in an ink tank. In the ink tank, the ink concentrate is diluted so that it is suitable to be dispensed onto the photoconductive surface. The diluted ink in the ink tank is continuously monitored and controlled so as to contain a suitable toner particle concentration.

The cans have several limitations. For example, the percentage of toner particles in the carrier liquid has to be under approximately 24%. With higher concentrations, the viscosity is too high to be handled by existing LEP systems. In addition, the high pressure on more concentrated systems (24% and higher) can cause ink agglomeration and result in print quality degradation. Moreover, it is difficult to maintain a constant toner particle concentration in the carrier fluid throughout the life of the cans, which may have a negative effect on the ink concentration in the ink tank and on its conductivity.

Currently it is not possible to satisfactorily empty the ink can. An amount of ink having a high solid concentration remains in the ink can after usage, for example in the range of 1% to 3% of the original ink amount before usage. Moreover, the toner particle concentration within a single ink can varies during its lifetime in the LEP system, which makes the density and conductivity of the ink difficult to control. Also, the transport, disposal and weight characteristics of the can make its use relatively inefficient.

It may be one of the goals of the invention to provide a more efficient container for toner ink for LEP.

### BRIEF DESCRIPTION OF THE DRAWINGS

For the purpose of illustration, certain embodiments of the present invention will now be described with reference to the accompanying diagrammatic drawings, in which:

FIG. 1 schematically shows a liquid electrostatic printing (LEP) system in side view;

FIG. 2 schematically shows a container connected to a LEP system in side view;

FIG. 3 schematically shows a container connected to a LEP system in front view;

FIG. 4 shows a flow chart of a method of printing.

### DETAILED DESCRIPTION

In the following detailed description, reference is made to the accompanying drawings. The embodiments in the description and drawings should be considered illustrative and are not to be considered as limiting to the specific embodiment of element described. Multiple embodiments may be derived from the following description through modification, combination or variation of certain elements. Furthermore, it may be understood that also embodiments or elements that may not be specifically disclosed may be derived from the description and drawings.

In this description, reference may be made to ink concentrates and imaging ink. Ink concentrate comprises carrier fluid containing a relatively high concentration of colored toner particles. The ink concentrate may have a relatively high viscosity, for example at least approximately 10000 cP (centipoises), as compared to imaging ink, i.e. ink that is used for printing. The ink concentrate referred to in this description may for example be known in the field as ElectroInk®™. In a printing process, the ink concentrate may later be further liquefied to allow better dispensing, dispersing and/or printing. The ink that is further diluted for printing may be referred to as imaging ink. The imaging ink may also be used to dilute the ink concentrate.

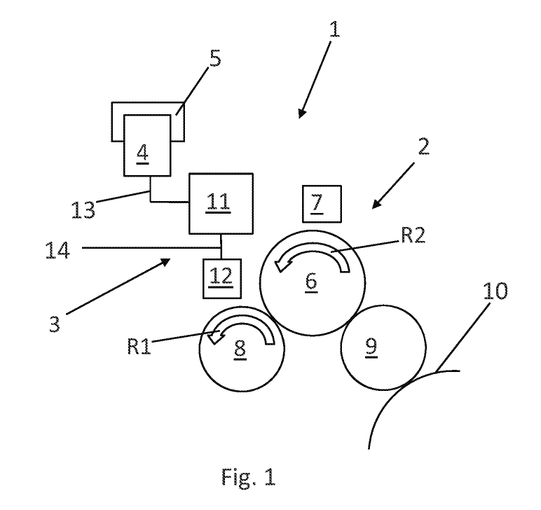

In FIG. 1 a LEP (Liquid Electrostatic Printing) system 1 is shown. The system 1 may comprise an electrostatic image arrangement 2, an ink dispenser 3, and an ink concentrate container 4. The system 1 may comprise multiple ink concentrate containers 4 having different toner colors, for example C (Cyan), M (Magenta), Y (Yellow) and K (Key). The ink concentrate container 4 may be connected to the LEP system 1 by a support arrangement 5 so that the container 4 may be exchanged.

The ink concentrate container 4 may comprise toner ink concentrate, having a relatively high concentration of colored toner particles in a carrier fluid. The ink dispenser 3 may be arranged to receive the ink concentrate from the or each ink concentrate container 4, further liquefy it, and dispense the resulting imaging ink onto the electrostatic image arrangement 2. The imaging ink may comprise the ink concentrate that is mixed with carrier fluid, so that it is suitable for electrostatic image development and/or for being developed. Consequently, in this description, the imaging ink may have a lower concentration of toner particles than the ink concentrate in the ink concentrate container 4, and a lower viscosity.

The electrostatic image arrangement 2 may comprise an electrostatic image member 6. The electrostatic image member 6 may comprise a photoconductor arranged to selectively charge and/or discharge its surface according to a received light pattern of a predetermined wavelength. The electrostatic image member 2 may comprise a photoconductive imaging sheet located on a rotational drum. For example, the photoconductive imaging sheet may comprise a photoreceptor of an organic type or of a non-organic type photoconductor, for example Selenium or amorphous Silicon.

The electrostatic image arrangement 2 may further comprise an imaging device 7. The imaging device 7 may comprise a charging device and a light device. The charging device may be arranged to charge the electrostatic image member 6 with a certain electrical potential. For example, the charging device may comprise a corotron, scorotron or roller charger. The light device may for example comprise a modulated laser beam scanning apparatus, or another laser arrangement. The light device may comprise an optical focusing device for focusing the light onto the photoconductor. The light device may be arranged to at least partially discharge the photoconductive imaging surface of the electrostatic image member 6 by emitting light of a suitable wavelength range. The selective discharging may produce an electrostatic latent image on the imaging surface having a different potential than the initial potential of the charged surface. After the selective discharging, the surface of the electrostatic image member 6 may comprise an image area, i.e. the “print portion”, at a first electrical potential and a background area at a second electrical potential.

The electrostatic image arrangement 2 may further comprise a development member 8. The development member 8 may comprise a rotational drum. The development member 8 may be arranged to be charged with an electrical potential to aid development of the latent electrostatic image. The electrical potential of the development member 8 may be between the electrical potential of the background area and the potential of the image area of the charged electrostatic image member 6. The rotational direction R1 of the development member 8 may be the same as the rotational direction R2 of the electrostatic image member 6, so that the development member 8 may have an opposite velocity with respect to the electrostatic image member 6. At the nearest point from the electrostatic image member 6, the surface of the development member 8 may extend at a small distance from the surface of the electrostatic image member 6, for example 150 micrometers or less. When the development member 8 and the electrostatic image member 6 are rotating, the respective toner particles on the development member 8 passing by the at least partially discharged electrostatic image member 6 may be transferred to the image area, drawn by the electric potential difference between the image area and the development member 8.

One or multiple development members 8 may be provided for one or multiple colors, wherein multiple different imaging inks may be transferred for printing a multicolor image. Multiple containers 4 may be connected to multiple ink dispensers 3 for dispensing the ink onto multiple corresponding development members 8. Each of the development members 8 may transfer its one-color print image to the electrostatic image member 6

The electrostatic image arrangement 2 may further comprise an intermediate transfer member 9. The intermediate transfer member 9 may be arranged to transfer the toner images from the electrostatic image member 6 to a medium 10. The intermediate transfer member 9 may comprise an exchangeable blanket.

The above described electrostatic image arrangement 2 may be approximately the same, or similar, as the LEP systems described in U.S. Pat. Nos. 4,678,317; 4,860,924; 4,980,259; 4,985,732; 5,028,964; 5,034,778; 5,047,808; 5,078,504; 5,117,263; 5,148,222; 5,157,238; 5,166,734; 5,208,130; 5,231,454; 5,255,058; 5,266,435; 5,268,687; 5,270,776; 5,276,492; 5,278,615; 5,280,326; 5,286,948; 5,289,238; 5,315,321; 5,335,054; 5,337,131; 5,376,491; 5,380,611; 5,426,491; 5,436,706; 5,497,222; 5,508,790; 5,527,652; 5,552,875; 5,555,185; 5,557,376; 5,558,970; 5,570,193 and 5,923,929, amongst others, herein incorporated by reference. The electrostatic image arrangement 2 and parts of the ink dispenser 3 may be approximately the same, or similar as the LEP system currently known as Indigo Digital Press®™.

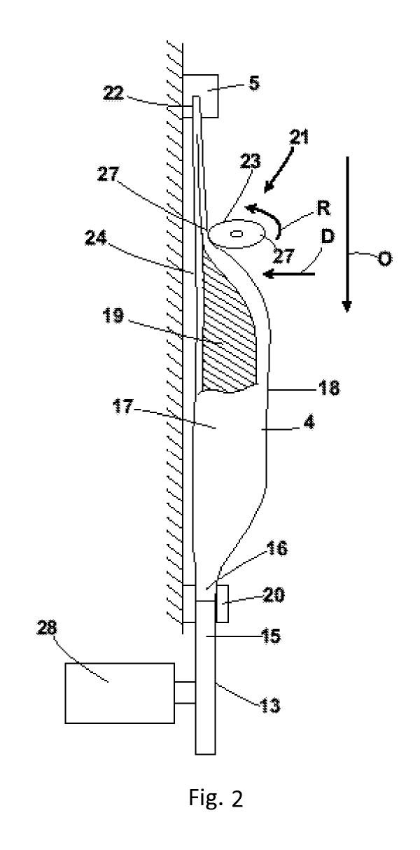

The ink dispenser 3 may be arranged to dilute the ink concentrate, and dispense the resulting imaging ink onto the imaging arrangement 2. Thereto, the ink dispenser 3 may comprise an ink tank 11, an ink development assembly 12, and ink conduits 13, 14. A first conduit 13 may be connected to the ink concentrate container 4. The conduit 13 may comprise an inlet 15 (FIG. 2). The inlet 15 of the ink dispenser 3 may be connected to the outlet 16 of the ink concentrate container 4.

The ink tank 11 may be in fluid connection with a carrier fluid supply (not shown) to receive carrier fluid. The ink tank 11 may be in fluid connection with the ink concentrate container 4 for receiving the ink concentrate. The carrier fluid and the ink concentrate may be mixed inside and/or outside the ink tank 11. Imaging ink may be dispensed onto the electrostatic image arrangement 2 from the ink tank 11. A sensor and mixing tools may be provided for maintaining a suitable concentration of toner particles in the imaging ink. Multiple ink tanks 11 may be provided, wherein each of the ink tank 11 may be connected to a corresponding ink concentrate container 4 containing a single colored ink concentrate.

The development assembly 12 may be arranged to transport the imaging ink from the ink tank 11 to the image arrangement 2. The ink development assembly 12 may be arranged to deposit the imaging ink onto the electrostatic image arrangement 2, for example onto the development member 8 and/or onto the electrostatic image member 6, for further development of the image on the electrostatic image member 6. The development assembly 12 may be arranged to selectively deposit one of multiple available single colored imaging inks onto the electrostatic image arrangement 2.

The ink concentrate may comprise electrically chargeable colored toner particles for liquid electrostatic imaging, in a carrier liquid. In the ink concentrate, the concentration of toner particles that is dispersed in the carrier liquid may be relatively high, for example approximately 18 weight percent or higher, or for example approximately 24 weight percent or higher. Hence, the ink may have a relatively high viscosity, which may be at least approximately 10000, for example between approximately 10000 and approximately 20000 cP (centipoises), for example at relatively low shear rates. The toner particles may comprise polymer resins, organic and inorganic pigments, solid additives such as, but not limited to, waxes, salts and/or surfactants, and/or liquid additives, such as but not limited to, oils, silicones, surface active agents and/or de-foamers. The toner particles may comprise swelled pigmented resin, wherein the carrier liquid contains a variety of liquid and soluble additives. In the field, the toner particles may be referred to as solid toner particles. The ink concentrate may further comprise charge control agents. However, the charge control agents may also be present in the imaging ink, and/or may for example be added before dispensing the imaging ink onto the imaging arrangement 2. The carrier liquid may comprise aliphatic and/or hydrocarbon liquid and/or dielectric oil.

The ink concentrate and carrier fluid may be such as described in at least one of the following publications, herein incorporated by reference. U.S. Pat. Nos. 4,794,651; 4,842,974; 5,047,306; 5,407,307; 5,192,638; 5,208,130; 5,225,306; 5,264,312; 5,266,435; 5,286,593; 5,300,390; 5,346,796; 5,407,771; 5,554,476; 5,655,194; 5,792,584; 5,5923,929 and 6,146,803, and POT Patent publication WO/92/17823, amongst others.

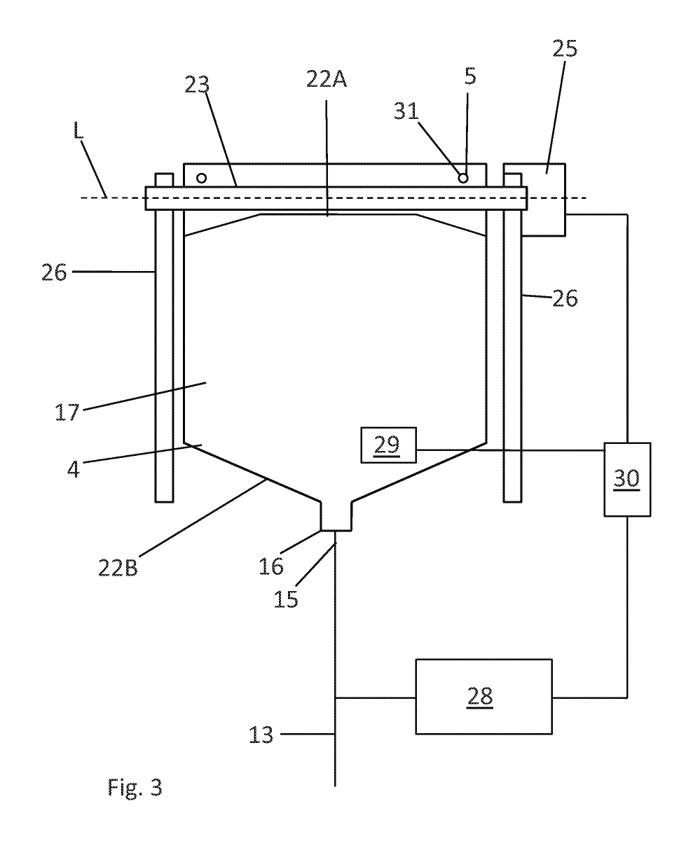

With reference to FIGS. 2 and 3, the ink concentrate container 4 may comprise an inner volume 17, and at least one flexible wall 18 extending along the inner volume 17. The ink concentrate container 4 may comprise an outlet 16 for dispensing the ink concentrate 19. By pressing the flexible wall 18 into the inner volume 17, the inner volume 17 may be decreased and the ink concentrate 19 may be pressed out. The container 4 may comprise a substantially flexible pouch. The inner volume 17 may be surrounded by flexible walls so that the inner volume 17 may be decreased in any direction.

The support arrangement 5 may comprise support members arranged to allow the container 4 to suspend from the support members. The container 4 may be connected to the support members in a suspending condition near the top part 22 of the container 4. The container 4 and the support arrangement 5 may be arranged to manually exchange the container 4. The container 4 may be taken from the support arrangement 5 when it is at least substantially empty and may be replaced by a filled container 4.

The container 4 may substantially comprise flexible material, so as to be easily folded, disposed and/or to allow efficient transport, storage and disposal in an empty condition. The total volume of the container 4 in an empty condition may comprise less than or equal to approximately 6% of the total volume of the container 4 in a fully filled condition.

The at least one flexible wall 18 of the container 4 may comprise plastic such as PET or PE. The container 4 may comprise a bag substantially comprising a flexible plastic such as PET or PE. The container 4 may substantially comprise a round, cylindrical, box like or bag like shape or any other suitable shape. The container 4 may comprise one integrated flexible wall 18. The container 4 may comprise biodegradable material so as to be disposed in an environment friendly manner after usage. The container 4 may comprise at least partly transparent walls so that the color of the ink concentrate can be presented through the respective wall part. The container 4 may comprise a stand up pouch. The container 4 may comprise a handle.

The container 4 may comprise at least one multi-layer wall. The layer may comprise a top layer, an intermediate layer and a sealing layer that may be laminated by adhesives. The lamination strength may be approximately 500 grams per inch (2.54 centimeter) or more. The seal strength may be approximately 100N per inch. The container 4 may be arranged to withstand a pressure difference between the inside and the outside of the container 4 of at least 0.8 bar.

Before use, the outlet 16 may comprise a special sealing that is able to withstand a pressure difference between the inside and the outside of the container 4 of approximately 2 bar, or 4 bar or higher pressures. The Moisture Vapor Transfer Rate (MVTR) and/or the Oxygen Transfer Rate (OTR) of the material of the wall may be approximately 0.02 gram or cubic centimeters per square meter per 24 hours or less, or approximately 0.01 gram or cubic centimeters per square meter per 24 hours or less. These rates may for example apply to approximately 64 days test over a surface area of approximately 0.075 square meters.

In an embodiment, the container 4 may comprise a flexible pouch. The filling of the pouch with ink concentrate 19 may for example be through the outlet 16. An opening may be created or may be present before filling, for example near the top part 22, wherein after filling the opening may be closed.

The inner volume 17 may be between approximately 0.3 and 5 liters, for example between 0.5 and 3 liters. The outlet 16 of the container 4 may comprise a nozzle. The outlet 16 may comprise a valve. The outlet 16 may be arranged to dispense small quantities of ink concentrate 19.

The outlet 16 of the container may be connected to the inlet 15 of the ink dispenser 3 so that the ink may flow from the container 4 to the ink dispenser 3. A closure element 20 may be provided to prevent possible leakage of liquid between the inlet 15 with the outlet 16, and optionally to aid in connecting the inlet 15 and the outlet 16. At least one of the inlet 15, the outlet 16, and the closure element 20 may comprise a valve arrangement. Such valve arrangement may aid in closing the container 4, and/or allowing two directional flow of fluid into and/or out of the container 4, as will be explained below.

A pressure arrangement 21 may be provided that is arranged to press against the flexible wall 18, so as to decrease the inner volume 17 and press out the ink concentrate 19. For example, the pressure arrangement 21 may locally move the flexible wall 18 in a direction D towards the inner volume, which may be perpendicular to the direction of fluid outflow O, which may be a direction from the top 22 of the bag to the outlet 16.

The pressure arrangement 21 may comprise a pressure member 23. The pressure member 23 may comprise a bar. Pressure arrangement 21 may be arranged to move the pressure member 23 so as to press the flexible wall 18 into the inner volume 17. The longitudinal axis L of the pressure member 23 may extend perpendicular to its direction of movement, a vertical direction, and/or the direction of outflow O (see FIGS. 2 and 3). The pressure arrangement 21 may be arranged to move the pressure member in the direction O of the outlet 16. The pressure member 23 may extend close to the back 24 of the container 4, so as to press the flexible wall 18 into the inner volume 17, against or in the direction of the opposite wall 24, while the pressure member 23 is moved downwards. The pressure member 23 may extend at a distance from the opposite wall 24 that corresponds to the thickness of the flexible wall 18, for example several micrometers or millimeters, so as to bring along most ink concentrate 19 while moving downwards along the flexible wall 18.

In certain embodiments, the pressure member 23 may comprise a roller. In other embodiments, the pressure arrangement 21 may comprise other pressure members 23 instead of a bar, that may have similar functions as the bar, such as, but not limited to, an air pressure arrangement, a bellows, a plate member, a piston moving along the side of the container 4, or another member that may be arranged to push the flexible wall 18 into the inner volume 17, for example in a direction O towards the outlet 16, for dispensing the ink concentrate 19 out of outlet 16.

The pressure arrangement 21 may comprise a drive arrangement 25 for driving the pressure member 23. The drive arrangement 25 may comprise an electromotor and/or a pneumatic and/or a hydraulic arrangement for moving the pressure member 23. The pressure arrangement 21 may comprise guides 26 for moving the pressure member 23 in the direction O of the outlet 16. The drive arrangement 25 may be controlled by a control circuit 30.

As shown in FIG. 3, the inner volume of the container 4 may have a tapering shape at the top 22 and/or at the bottom. This may facilitate pressing ink concentrate 19 out of the inner volume 17 when the pressure member 23 moves along the respective top and/or bottom.

The pressure member 23 may be arranged to rotate around a rotation axis A. In the shown example of FIG. 3, the rotation axis is the longitudinal axis L of the pressure member 23. The pressure member 23 may comprise a bar having a non-symmetrical shape. For example, the cross-section of the bar may be substantially elliptical, as can be seen from FIG. 2. Rotating the bar may cause the circumferential surface to move in the direction D of the inner volume 17, and/or away from the inner volume 17. The flexible wall 17 may move partly into the inner volume 17 by such rotation, or away from the inner volume 17, decreasing or increasing the inner volume 17, respectively. Rotational movement R of the bar may aid in pressing out the toner fluid 19 and/or in preventing precipitation of toner particles.

The LEP system 1 may further comprise an auxiliary pump 28, schematically illustrated in FIG. 2. The auxiliary pump 28 may be connected to the inner volume 17 of the container 4. The auxiliary pump 28 may be connected to the outlet 16. The auxiliary pump 28 may be arranged to pump the ink concentrate 19 out of the inner volume. The auxiliary pump 28 may aid in pressing the ink concentrate 19 out of the container 4 in addition to the pressure arrangement 21.

The auxiliary pump 28 may further be arranged to pump a second liquid into the container 4. Such second liquid may comprise a second ink that may comprise the carrier liquid having a concentration of toner particles that is lower than the concentration of toner particles in the ink concentrate 19, so that mixture of the ink concentrate 19 with the second ink may prevent an increase of toner particle concentration. The result of the mixture may be that the ink concentrate 19 in the container 4 may have a slightly higher toner particle concentration and viscosity. The second liquid may also comprise carrier fluid, not necessarily having toner particles. The second liquid may comprise the imaging ink, which may for example be obtained from the ink tank 11. A toner concentration sensor 29 may be provided to detect the toner particle concentration and/or a certain change in the toner particle concentration. A control circuit 30 may be provided to drive the pump according to signals received from the toner concentration sensor 29. The control circuit 30 may further be arranged to drive the valve assembly, for example to control the multi-directional flow of ink into and out of the container 4.

The pump 28 may be arranged to pump in two directions. The pump 28 may be arranged to pump the second ink in the direction of the container 4, and to pump ink concentrate 19 out of the container 4. The pump 28 may comprise a polarity switch so as to switch pump direction. The control circuit 30 may be configured to switch the polarity of the pump 28.

The second ink may be arranged to decrease the concentration of toner particles in the ink concentrate 19 in the ink concentrate container 4. This may keep the toner particle concentration at a desired level but may also aid in emptying the container 4 and/or prevention of clogging in the container 4, in the conduits 13 and/or in the pump 28.

The control circuit 30 may be configured to control the drive arrangement 25 for driving the pressure arrangement 21. The control circuit 30 may be arranged to drive and/or rotate the pressure member 23 in a direction away from the outlet 16, when the pump 28 pumps the second liquid in the direction of the container 4, so that the pressure member 23 is realigned in case the inner volume 17 may be increased due to injection of the second ink.

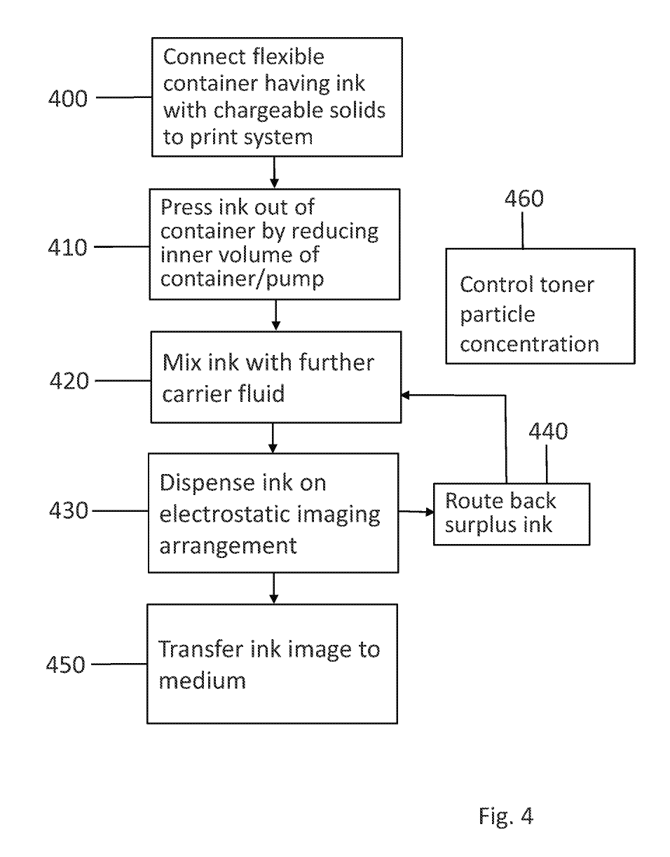

A method of using the container 4 with at least one flexible wall 18 can be explained with reference to FIG. 4. In step 400, container 4 may be connected to the LEP system 1. The container 4 may be connected to the support arrangement 5. The top 22A of the container 4 may be connected to the support arrangement 5, so that the container 4 may suspend from the support arrangement 5. For example, the container 4 may comprise female elements 31, such as holes, and the support arrangement 5 may comprise protrusions for extending in and/or through the female elements 31. The outlet 16 of the container 4 may be connected to the inlet 15 of the ink dispenser 3, i.e. the ink tank 11. The container 4 may be positioned with respect to the pressure arrangement 21 in a condition for use. The pressure member 23 may be in a retracted position to allow positioning of the container 4.

In step 410, the flexible wall 18 may be deformed so that the inner volume 17 decreases. The pressure member 23 may move towards the outlet 16, while it extends relatively close to the back wall, i.e. opposite wall 24, thereby bringing the flexible wall 18 closer to the opposite wall 24, decreasing the inner volume 17, and pushing the ink concentrate 19 out of the outlet 16. While pressing out the ink concentrate 19 with the pressure arrangement 2, the pump 28 may under pressurize the inner volume 17, in this way aiding in pressing the ink concentrate 19 out of the container 4. This may allow the exerted pressure by the pressure arrangement 2 and the pump 28 to be relatively low.

In step 420, the ink concentrate 19 that is pressed out of the container 4 may be mixed with further carrier fluid. The ink concentrate 19 may be pumped towards the ink tank 11 wherein the mixing may take place. Transport through the conduits 13, 14 of the ink concentrate 19 may be driven by the pressure arrangement 21 and/or the pump 28. Ink concentrate 19 and further carrier fluid may mix to provide for imaging ink having a toner particle concentration better suitable maintaining a relatively constant ink concentration in the ink tank 11 and allowing for a relatively constant conductivity

In step 430, the resulting imaging ink may be dispersed onto the electrostatic image arrangement 2. The imaging ink may be dispersed onto the development member 8 and/or on the image electrostatic image member 6. The imaging ink may be drawn by the electrical potential of the development member 8. The electrical potential of the statically charged image area of the electrostatic image member 6 may be such that the toner ink is drawn to the image area, and moves from the development member 8 to the electrostatic image member 6. The electrical potential of the statically charged background area of the electrostatic image member 6 may be such that the imaging ink is not drawn. The process of providing imaging ink onto the image area may be repeated for each toner color, wherein the light device may discharge an image pattern pertaining to each ink color. The charged toner particles may be drawn by the potential of the charged image area. The respective charged toner particles may adhere to the respective statically charged image area, while a surplus part of the imaging ink may be cleaned from the developing unit 12. This non-adhering surplus part of the imaging ink may be received by receiving means and routed back to the ink tank 11 in any suitable manner, in step 440.

In step 450, the image may be transferred to a medium. The ink on the image area may be transferred to an intermediate transfer member 9. The ink may be transferred from the intermediate transfer member 9 to the medium. The intermediate transfer member 9 may comprise an exchangeable disposable blanket. The medium containing the printed image may be further treated and/or taken off the LEP system 1.

Parallel to above steps, the toner particle concentration in the ink concentrate 19 may be controlled, as indicated by block 460. In an embodiment, the imaging ink may be pumped in the direction of the container 4 to mix with the ink concentrate 19. Thereto, the pump 28 may reverse pump direction, for example by switching its polarity, so as to guide ink concentrate, imaging ink or carrier fluid in the opposite direction. This may allow the toner particles concentration in the ink concentrate 19 to decrease. This may be advantageous to prevent dogging in the pump 28, conduits 13, outlet 16 and/or ink tank 11. The toner particles concentration in the pump 28, conduits 13, container 4 and/or ink tank 11 may be controlled by such action. A relatively uniform concentration of toner particles in the carrier fluid may be maintained in the pump 28, conduits 13, container 4, and/or in the ink tank 11.

In a further embodiment, a process of controlling the toner particles concentration in the ink concentrate 19, as indicated by block 460, may include the pressure arrangement 21 moving the flexible wall for moving and/or shaking the contents of the container 4. This may prevent precipitation of the toner particles and/or evenly disperse the toner particles throughout the carrier fluid. The outlet 16 may be closed off while the pressure arrangement 2 moves the contents of the container 4. The method may include moving the pressure member 23 towards and from the inner volume 17, for example so as to repetitively decrease and increase the inner volume 17, respectively, for example by rotating the non-symmetrical bar.

The orientation of the container 4, in use may be different than what is shown in FIG. 1-3. For example, the outlet 16 may be situated near a top or side part of the container 4. The pressure arrangement 21 may press the ink concentrate upwards, sideways and/or downwards, towards the outlet 16.

In tests, the application of a the flexible wall 18 for dispensing the ink concentrate 19 out of the container 4 has shown to be suitable for the inheritably viscous ink concentrate 19 for electrostatic imaging, whereas other solutions for this type of ink have shown to have difficulties to empty. In fact using the above presented container 4 may allow relatively high concentrations of toner particles in the ink concentrate, higher than currently possible. For example, the concentration of toner particles may be 22% or more, for example 24% or more, for example 30% or more, or even 40% or more. Using such high concentrations may be advantageous because more media may be printed per volume unit ink concentrate 19.

The substantially flexible container 4 has shown significant advantages in the LEP system 1 with respect to the cans. High pressurizing equipment for dispensing the ink concentrate out of the container 4 may be prevented, while dispensing may be better controlled. In particular, with the invention it may be possible to dispense relatively low amounts of ink concentrate from the container 4 in a controlled manner. The pressure arrangement 21 may press relatively small amounts of the relatively viscous ink concentrate out of the container 4 in a controlled manner. With the flexible container 4 it is possible to take out relatively small strokes of highly viscous material, e.g. at least 10000 cP, in a controlled mode. By controlling the delivery of ink concentrate to the ink tank, it is also better possible to better control the toner particle concentration in the imaging ink in the ink tank 11. For example, the toner concentration in the ink tank 11 may be maintained while the print system 1 is printing, and while relatively small amounts of ink concentrates and carrier fluid may be added to the tank 11.

Moreover, the use of the flexible container 4 may allow for emptying the container 4 until there is 0.3% or less residue left in the container 4. The containers 4 may be designed to contain less material and weight, in an empty condition, and as such may be relatively cost effective and environment friendly.

In a first aspect, an ink concentrate container 4 may be provided, comprising (i) an inner volume 17, containing ink concentrate 19 for liquid electrostatic printing (LEP), the ink concentrate 19 comprising a carrier liquid and electrically chargeable toner particles for electrostatic imaging, (ii) an outlet 16, and (id) at least one flexible wall 18 extending along the inner volume 17, so that ink concentrate 19 can be pressed through the outlet 16 out of the inner volume 17 by deforming the flexible wall 18.

In a second aspect, a method of printing is provided, comprising (i) connecting an outlet 16 of an ink concentrate container 4 to an inlet 15 of an ink dispenser 3 in a liquid electrostatic print system 1, the ink concentrate container 4 containing ink concentrate 19 for liquid electrostatic printing in its inner volume 19, the ink concentrate 19 comprising a carrier liquid and electrically chargeable toner particles, (ii) deforming at least one flexible wall 18 of the container 4 so that the inner volume 17 of the container 4 decreases, thereby pressing the ink concentrate 19 out of the container 4, and (iii) dispensing the diluted ink 19 onto a electrostatic image arrangement 2, and adhering the toner particles to a statically charged image area.

The above description is not intended to be exhaustive or to limit the invention to the embodiments disclosed. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, while a reference to a certain number of elements does not exclude the possibility having more elements. A single unit may fulfil the functions of several items recited in the disclosure, and several items recited in the disclosure may fulfil the function of one unit.

The mere fact that certain measures are recited in mutually different dependent claims does not indicate that a combination of these measured cannot be used to advantage. Multiple alternatives, equivalents, variations and combinations may be made without departing from the scope of the invention.

1. Ink concentrate container, comprising
an inner volume, containing ink concentrate for liquid electrostatic printing (LEP), the ink concentrate comprising a carrier liquid and electrically chargeable toner particles for electrostatic imaging,
an outlet, and
at least one flexible wall extending along the inner volume, so that ink concentrate can be pressed through the outlet out of the inner volume by deforming the flexible wall.

2. Ink concentrate container according to claim 1, wherein the carrier liquid comprises at least one of an aliphatic hydrocarbon liquid, and
the toner particles comprise at least one of polymer resins, organic and inorganic pigments, solid additives and liquid additives,
and the ink concentrate further comprises charge control agents.

3. Ink concentrate container according to claim 1, wherein the container comprises a flexible bag.

4. Ink concentrate container according to claim 1, the container being arranged so that the total volume of the container in an empty condition comprises less than or equal to approximately 6% of the total volume of the container in a fully filled condition.

5. Ink concentrate container according to claim 1, wherein at least approximately 18 weight percentage of the ink concentrate comprises toner particles, and the ink concentrate has a viscosity of at least approximately 10000 centipoises.

6. Print system, comprising
an electrostatic image arrangement for receiving imaging ink and deliver the imaging ink to a medium in correspondence with an input image,
an ink dispenser arranged to receive the ink concentrate, dilute the ink concentrate to make imaging ink, and dispense the imaging ink onto the electrostatic image arrangement,
a support arrangement for supporting the ink concentrate container in the print system in an exchangeable manner, and
the ink concentrate container according to claim 1, wherein
the outlet of the ink concentrate container is connected to an inlet of the ink dispenser for exchanging ink concentrate.

7. Print system according to claim 6, comprising a pressure arrangement for pressing against the flexible wall to press the ink concentrate out of the container.

8. Print system according to claim 7, wherein the pressure arrangement comprises a movable pressure member arranged to press the flexible wall at least partly into the inner volume to press out ink concentrate, and to at least partly move in a direction of the outlet for emptying the container.

9. Print system according to claim 8, wherein the pressure member extends along the width of the at least one flexible wall.

10. Print system according to claim 8, wherein the pressure member comprises a bar
arranged to rotate around a rotation axis, and
having a non-symmetrical shape around the rotation axis, to press the flexible wall at least partly into the inner volume when the bar rotates.

11. Print system according to claim 6, comprising a pump arranged to mix the ink concentrate with a second ink having a lower percentage of toner particles than the ink concentrate in the inner volume.

12. Print system according to claim 6, comprising a pump arranged to under pressurize the inner volume for pressing ink concentrate out of the inner volume.

13. Method of printing, comprising
connecting an outlet of an ink concentrate container to an inlet of an ink dispenser in an electrostatic image print system, the ink concentrate container containing ink concentrate for liquid electrostatic printing in its inner volume, the ink concentrate comprising a carrier liquid and electrically chargeable toner particles,
deforming at least one flexible wall of the container so that the inner volume of the container decreases, thereby pressing the ink concentrate out of the container, and
dispensing imaging ink resulting from the ink concentrate onto an electrostatic image arrangement, and
adhering the toner particles to a statically charged image area.

14. Method of printing according to claim 13, comprising,
mixing the ink concentrate with further carrier fluid, to obtain imaging ink,
under pressurizing the inner volume, while pressing against the at least one flexible wall,
reversing a pumping direction, and
pumping the imaging ink towards the container to mix with the ink concentrate.

15. Method of printing according to claim 13, comprising repetitively moving the at least one flexible wall, thereby dispersing the toner particles throughout the carrier fluid.
